(19) United States
(12) Patent Application Publication
(10) Pub. No.: US 2012/0226980 A1
(43) Pub. Date: Sep. 6, 2012

(54) RENDERING A WEB PAGE COMPRISING PLUG-IN CONTENT

(75) Inventors: Christian Maria Johannes Armand Quaedvlieg, Eindhoven (NL); Michel De Vries, Eindhoven (NL)

(73) Assignee: KONINKLIJKE PHILIPS ELECTRONICS N.V., EINDHOVEN (NL)

(21) Appl. No.: 13/508,057

(22) PCT Filed: Nov. 16, 2010
(86) PCT No.: PCT/IB10/55182

§ 371 Date: May 4, 2012

(30) Foreign Application Priority Data
Nov. 20, 2009 (EP) 09176573.5

(51) Int. Cl. G06F 3/01; G06F 15/16

(52) U.S. Cl. 715/716

(57) ABSTRACT

A method and system are described of rendering a web page comprising plug-in content at one or more locations in the web page. Not all plug-in content of the web page is automatically played. Instead, the user is enabled to select the plug-in content at a location for playing (130) and only the plug-in content that is selected by the user is played (140).

### BACKGROUND OF THE INVENTION

1. Technical Field

The present invention relates to the field of rendering content of web pages and more specifically to rendering plug-in content thereof.

2. Description of Related Art

Some high-end television sets currently enable the user to surf the open Internet. Examples thereof are the Philips television sets in the 8000 series, 9000 series and Cinema 21:9, which offer the NetTV® feature. A description of the NetTV® feature is available at “http://www.digitalnewsroom.philips.com/products/net-tv/. Through Net TV®, Internet content is tailored for the best possible viewing experience on the TV screen, and is easily accessed through the TV's remote control, without the need for extra set-top boxes or service subscriptions, or for starting up a PC. The user is provided the option to surf the web freely, i.e. type any URL, but there are some restrictions and limitations compared to surfing the web with a PC. Neither downloading nor uploading of files is possible and there is no plug-in support.

### SUMMARY OF THE INVENTION

It would be desirable to support the rendering of plug-in content, i.e. web content that cannot be initialized without installing a plug-in, i.e. an auxiliary computer program configured for handling the content (e.g. Adobe Flash). With plug-ins, it is possible to play streaming video, play online games, or listen to online music.

A downside of plug-in content is that it often requires high processor and memory resources to perform, properly. The generally limited processing and memory resources of high-end TV sets would render it cumbersome to provide full support for all plug-in content items found on one page. Due to the concurrent attempt of all plug-in content items to initialize, all available CPU and/or memory resources would be consumed. The system would then become slow and there would even be a risk of the browser/plug-in being closed.

Therefore, there is a need to apply a more intelligent approach to initiate plug-in content, in particular for devices having relatively limited processing and memory resources, in order not to overload device resources during page load.

To better address this concern, according to an aspect of the invention a method is provided of rendering a web page comprising plug-in content at one or more locations in the web page, the method comprising the steps of:
enabling a user to select the plug-in content at a location for playing, wherein the step of enabling comprises initializing the plug-in needed to play the plug-in content at the location; and
playing the selected plug-in content.

By playing only the plug-in content that is desired by the user, important savings of processor and memory use are obtained. This is particularly useful for consumer electronic devices having limited processing and memory resources, such as television sets low-end PCs, mobile telephones and net-books, because there is a reduced risk that the device becomes slow or needs to close the browser/plug-in.

According to an embodiment of the invention the method comprises a further step of choosing at least one plug-in content item and the step of enabling a user to select the plug-in content at a location for playing comprising a step of performing at least part of the initialization needed to play the chosen plug-in content item and a step of enabling a user to select the chosen plug-in content item at a location for playing. The choosing step may comprise choosing all plug-in content items present on the web page.

The degree of saving of processor and memory resources, which is desired or required, will define the number of plug-in content items in the web page chosen for initialization.

The step of performing at least part of the initialization needed to play the chosen plug-in content item comprises initializing the plug-in needed to play the plug-in content item corresponding to the location for playing and may additionally comprise initializing the plug-in content item corresponding to the location for playing. By initializing only the plug-in automatically and not the plug-in content item processor load becomes nil after the initialization and no memory resources are reserved for the plug-in content. However, the user is not provided beforehand (i.e. before selecting the content for playing) with information regarding the content item at that location. In case that the plug-in content item is initialized, the user is provided with information regarding the item before selecting it for playing. However, this results in a slightly reduced saving of memory use, because memory is reserved for the initialized content item. Preferably, the initializing plug-in content item is paused and the user is enabled to select the paused plug-in content item for playing. The paused plug-in content item is played upon the selection.

According to a further embodiment of the invention, the playing of the plug-in content item is discontinued, when the playing plug-in content item becomes invisible in a current view of the web page. Indeed, when due to the user scrolling this item is not visible anymore, there is no need to continue playing it. The effect is a further reduction of processor and memory use.

Preferably, the method according to the invention is implemented by means of a computer program.

The computer program may be embodied on a computer readable medium or a carrier medium may carry the computer program.

According to a further aspect of the invention, a system is provided comprising a controller for rendering a web page comprising plug-in content at one or more predetermined locations in the web page, wherein the controller is configured for:
enabling a user to select the plug-in content at a location for playing wherein the enabling comprises initializing the plug-in needed to play the plug-in content at the location; and
playing the selected plug-in content.

The controller can implement the method described above and can render the web page, accordingly. Consequently, the advantages resulting from the method can be achieved. Moreover, the controller can be modified so as to realize the preferred variants of the method described above.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 shows a flowchart of rendering a web page comprising plug-in content according to a first exemplary embodiment of the invention.

FIG. 2 shows the rendering of the web page on a TV screen.

FIG. 3 shows a flowchart of rendering a web page comprising plug-in content according to a second exemplary embodiment of the invention.

FIG. 4 shows a block diagram of a system for rendering web pages comprising plug-in content according to an exemplary embodiment of the invention.

Throughout the figures like reference numerals refer to like elements.

### DETAILED DESCRIPTION OF THE PRESENT INVENTION

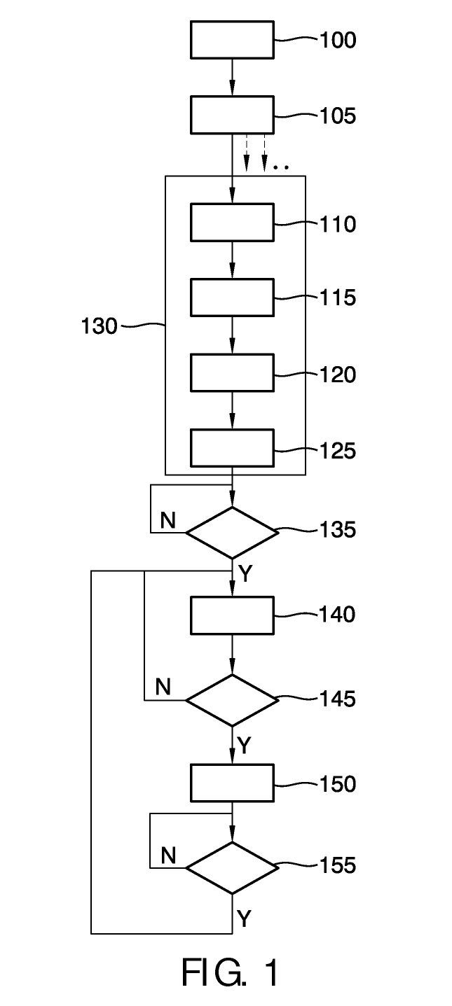

FIG. 1 shows a flowchart of rendering a web page comprising plug-in content at a plurality of locations in the page according to a first exemplary embodiment of the invention. The plug-in(s) needed to play the plug-in content are available at the device implementing the method. The web page is loaded and the “normal” (i.e. “non plug-in”) content thereof is rendered (step 100) by a web browser. Next, at least one of the plug-in content items contained in the web page is chosen (step 105). The plug-in content items may for example be chosen based on the expected interest of the user in the item. Alternatively, the choosing step comprises choosing all plug-in content items present on the web page. Then for each of the chosen plug-in content items, the following steps are performed. The plug-in corresponding to the content item is initialized (step 110). Downloading of the plug-in content item is started and one or a few frames thereof are played (step 115). The plug-in content item is paused (step 120) and made selectable (“clickable”) (step 125), in order to be able to play the content again (after clicking) By playing one or a few frames of the selectable plug-in content item and then pausing it, an initial screen shot of the content item is generated and the user is provided with an image representing the plug-in content item. This is helpful for the user in deciding which plug-in content items should be selected for playing and which items should not. The steps 115 and 120 together correspond to the initialization of the plug-in content item. The steps 110,115,120 and 125 together correspond to the enabling of the user to select the plug-in content item at a location for playing (step 130).

Now, it is determined if a user selects the paused plug-in content item for playing (step 135). If this is the case, playing of the paused content is resumed (step 140).

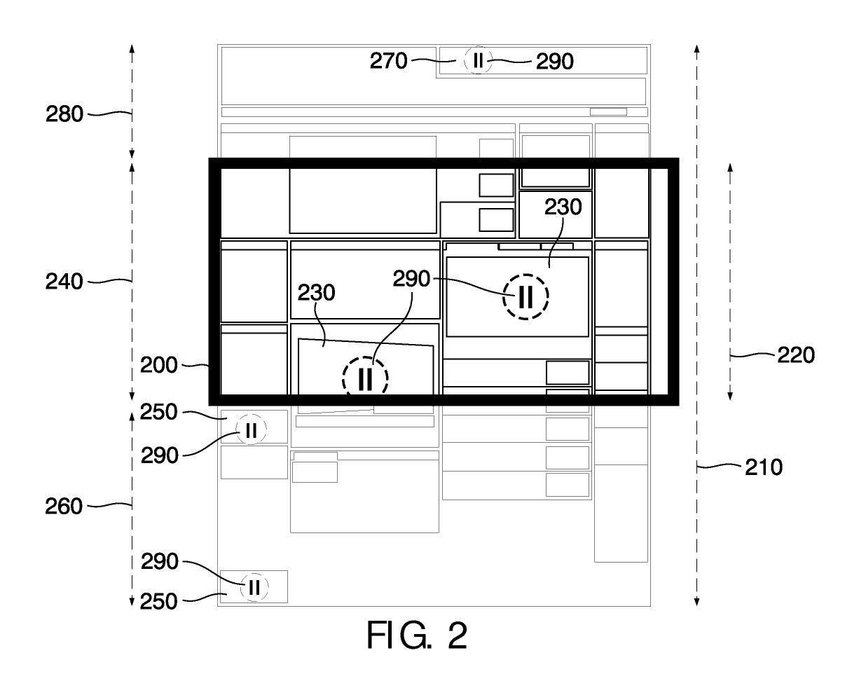

FIG. 2 shows the rendering of the web page on a TV screen 200 for the case that in step 105 all plug-in content items of the web page are chosen. Generally, the content height 210 of the web page is larger than the screen height 220 of the TV screen. Plug-in content 230 at locations in the visible part 240 of the web page is in the initialized state, is selectable and can be playing. The plug-in content in the initialized and selectable state has a pause sign 290 superimposed on the paused image thereof, thereby indicating to the user that the plug-in content is initialized (paused) and selectable. Plug-in content 250 in the part 260 of the web page, which has not been visible yet, is in the initialized state and is selectable but cannot be playing. The fact that the plug-in content 250 is selectable is not of any practical value, as long as it remains invisible. However, as soon as it becomes visible it can be directly selected for playing by the user, without the need of any additional processing to put it in the selectable state. Also plug-in content 270 in the part 280 of the web page, which is not visible in the current view but has been visible before, is in the initialized state and is selectable but cannot be playing.

Now turning to FIG. 1 again, it is determined if the playing content item becomes invisible due to user scrolling of the page (step 145). To this end, the position of the HTML elements or objects in the web page representing the plug-in content is monitored. If the content becomes invisible, the playing of the content is discontinued (the content is “auto-paused”, step 150). Next, it is determined if the plug-in content item for which the playing was discontinued becomes visible again (step 155). If this is the case, playing is automatically resumed (step 140). According to an alternative implementation, the plug-in content item is reset to the initialized and selectable state and the user should select it for resuming the playing thereof.

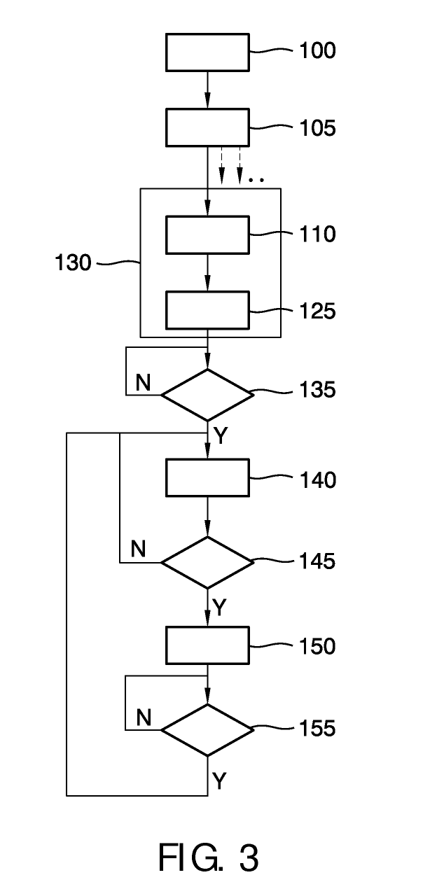

FIG. 3 shows a second exemplary embodiment of the rendering of a web page according to the present invention. Herein, the step of initializing the plug-in content item is omitted. Consequently, no memory resources are needed for storing initialized plug-in content, which has not yet been selected for playing by the user. However, the user has to take the decision which plug-in content items to select for playing without any information regarding the content.

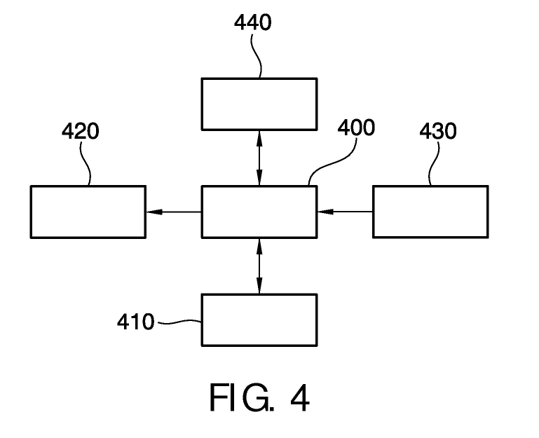

FIG. 4 shows a block diagram of an exemplary system for implementing the present invention. Only those features relevant for generating the present invention are shown. It comprises a controller (processor) 400 with an associated memory 410, a display (e.g. a TV screen) 420, an input device 430 (e.g. a remote control) enabling the user to provide input commands and an interface unit 440, such as a router or modem for connection to the Internet. The functionality shown in FIGS. 1-3 is preferably implemented by means of a suitable computer program loaded to the associated memory of the processor 400. The system is preferably used in devices with limited resources in terms of processing power and memory, such as television sets, mobile telephones, low-end PCs and net-books.

While the invention has been illustrated and described in detail in the drawings and foregoing description, such illustration and description are to be considered illustrative or exemplary and not restrictive; the invention is not limited to the disclosed embodiments.

In this regard it is to be noted that plug-ins are also often referred to as add-ins, add-ons or snap-ins. However, the meaning of these terms is equivalent to plug-in, i.e. they refer to an auxiliary computer program that interacts with the web browser to provide a certain functionality. For this reason, the term “plug-in” in the appended claims should be interpreted to embrace also these alternative terms that have an equivalent meaning

Furthermore, instead of or additionally to automatically discontinuing the playing of the content items, when they become invisible, as in the embodiments shown in FIGS. 1 and 3, the user may be provided with an option to stop the playing of the content items.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Method of rendering a web page comprising plug-in content at one or more locations in the web page, the method comprising:
enabling a user to select the plug-in content at a location for playing, wherein enabling comprises initializing the plug-in needed to play the plug-in content at the location; and
playing the selected plug-in content.

2. Method according to claim 1, further comprising choosing at least one plug-in content item and enabling a user to select the plug-in content at a location for playing comprising performing at least part of the initialization needed to play the chosen plug-in content item and enabling a user to select the chosen plug-in content item at a location for playing.

3. Method according to claim 2, wherein choosing comprises choosing all plug-in content items present on the web page.

4. Method according to claim 1, wherein enabling comprises initializing the plug-in content.

5. Method according to claim 4, wherein the initializing of the plug-in content comprises pausing the plug-in content.

6. Method according to claim 5, comprising:
enabling a user to select the paused plug-in content for playing; and
playing the paused plug-in content upon the selection.

7. Method according to claim 6, further comprising discontinuing the playing of the plug-in content, when the playing plug-in content becomes invisible in a current view of the web page.

8. A computer program comprising computer program code adapted to perform according to claim 1 when said program is run on a computer.

9. System comprising a controller for rendering a web page comprising plug-in content at one or more predetermined locations in the web page, wherein the controller is configured for:
enabling a user to select the plug-in content at a location for playing, wherein the enabling comprises initializing the plug-in needed to play the plug-in content at the location; and
playing the selected plug-in content.

10. System according to claim 9, wherein the controller is configured for choosing at least one plug-in content item and enabling a user to select the plug-in content at a location for playing comprises performing at least part of the initialization needed to play the chosen plug-in content item and enabling a user to select the chosen plug-in content item at a location for playing.

11. System according to claim 10, wherein choosing comprises choosing all plug-in content items present on the web page.

12. System according to claim 9, wherein the enabling furthermore comprises initializing the plug-in content.

13. System according to claim 12, wherein the initializing of the plug-in content comprises pausing the plug-in content.
